(19) United States
(12) Patent Application Publication
(10) Pub. No.: US 2015/0379598 A1
(43) Pub. Date: Dec. 31, 2015

(54) DATA PROCESSING SYSTEM AND METHOD

(71) Applicant: ONGRAND LIMITED, Apia (WS)

(72) Inventors: Shih-Fong LEE, Yuanlin Town (TW); Wen-Fu LEE, Taipei City (TW); Tsung-Yueh CHENG, Taipei City (TW)

(21) Appl. No.: 14/317,388

(22) Filed: Jun. 27, 2014

(51) Int. Cl. G06Q 30/06; H04L 29/08; G06Q 50/16; H04L 29/06

(52) U.S. Cl. CPC G06Q 30/0609; H04L 67/42; H04L 67/10; G06Q 30/0613; G06Q 50/16

(57) ABSTRACT

A data processing system and method are disclosed, employed in a cloud environment of a distributed system to process/exchange data. When performing the data processing method using the data processing system, first, a basic information directory is set with conditions/terms according to a specific subject matter. Next, repeated action is performed on the basic information directory between users, so as to initiate conditions/terms iteration, generate derivative information directories and incident group composition changes. Last, for the basic information directories and/or derivative information directories, a term-specified group composed of users is formed by users, and terms of transaction is negotiated between users for a specific subject matter, that is, for the derivative information directory created by iteration and/or basic information directories that are related to the specific subject matter, the term-specified group is formed by users who have reviewed/read and accepted all the conditions/terms of the directory.

### BACKGROUND OF THE INVENTION

1. Field of the Invention

The present invention relates to a data processing system and method, and more particularly, to a data processing system and method employed in a cloud environment of a distributed system for data processing/exchanging. For the basic information directory and/or the derivative information directories generated based on a specific subject matter during a reciprocal interoperation process, a term-specified group is formed including the users who have accessed and accepted all the conditions/terms of the directories by recruiting interoperable groups. The members of the interoperable groups are able to perform reciprocal interoperation, and the users of the term-specified group then negotiate the conditions/terms of transaction for the specific subject matter.

2. the Prior Arts

In the real world, the subject matter, price and other terms of a transaction are usually determined after repeated times of negotiations, for example, in a transaction between multiple users, e.g. group buying, or in a transaction of differentiated subject matter, e.g. second-hand real estate transaction.

On a general e-commerce website, the website serves as the agent in the contracting process of offer/acceptance during a transaction. Herein, the browsers of each website are seen as individuals respectively, and the website is only the mediator who provides the platform for the buyers and the sellers, e.g. individuals or groups, to perform e-commerce transactions.

On a shopping website, the website is considered as the seller, and the browsers of the website, e.g. individuals or groups, are considered as the buyers. The transaction is performed between the seller and the buyer based on the price of the commercial goods. Alternatively, the shopping website can also provide a platform for the seller, and the browsers of the website, e.g. individuals or groups, are the bidder for the commercial goods. In this situation, the transaction is performed between the seller and the highest bidder. In addition, on a group buying website, discount vouchers on different goods are provided based on the number of people in the group.

Nevertheless, in the above-described transactions, transactions can only be performed on the platform provided by the website when the conditions of the buyer matches all the terms and conditions provided by the seller, or vice versa. When a condition of the buyer does not match the condition provided by the seller, the transaction cannot be proceeded, and vice versa. In other words, the transaction can only be performed when all the conditions and terms of the buyer and the seller match each other. If one of the conditions of the buyer and/or the seller does not match, the transaction cannot be performed. Strictly speaking, on the currently available websites, the potential buyers and the sellers are not able to openly participate in the negotiation process for a specific subject matter, not to mention the negotiation process for differentiated subject matters, such as the negotiation process of real estate transactions. In addition, different opinions from different parties involved are not able to be collected. Thus, the transaction cannot be performed with accumulative negotiations.

Hence, there is an urgent need of the industry to seek a data processing system and method, which allows the parties involved in the transaction to interact with each other. In such system and method, users are recruited into an interoperable group to become parties involved in a negotiation. The system and method shall allow the buyers and the sellers (individuals or groups) to negotiate with each other over the terms and conditions of the transaction in the process of reciprocal interoperation. In this way, the parties involved in the transaction can discard their differences and the different needs among the users can be converged. The different opinions of the parties involved shall also be separated to generate a new interoperable group for further interoperation; thus, the seller and the buyers are able to interoperate with each other, and the transaction can be performed based on the accumulative negotiations.

### SUMMARY OF THE INVENTION

The present invention is a data processing system and method. The present invention recruits interoperable group in the cloud environment to discard difference between conditions/terms by interoperation, and also map the conditions/terms provided by each members with different derivative directories. A term-specified group is formed by the users who have discarded their differences, in other words, is formed by the users who have reached convergence in their results of interoperation. For the clarity of explanation, the seeking of the opportunities of buying and selling, recruiting and negotiation process that leads to successful transaction (i.e. convergence) will be used as examples in the following embodiments.

The present invention provides a system and method. More specifically, the system and method of the present invention utilize a distributed system to recruit non-specified users to form an interoperable group for performing reciprocal iteration. The distributed system is a set of software for transmitting messages between computer groups connected by internet. In this way, a common goal can be achieved through communication, coordination and interoperation. Herein, interoperability is defined as the ability to exchange data with a same set of exchange format between different elements composing a system so as to work collaboratively (i.e. interoperate).

Iteration is an activity which repeats the process of feedback to approach a desired target or result. One “iteration” process is considered performed whenever a process is repeated. The result of one iteration process is used as the initial value of the next iteration. Reciprocal iteration is a process repeatedly performed among users of the distributed system, and is a cycle formed by two reversing processes. One is to transmit/process initial information inputted by one user; the other is to transmit/process the feedback information by other users.

During the process of iteration, the information provided by the users, including the initial information and the feedback information, is considered as input of the distributed system. Such information can comprise product description, invitation for group-on, inquiry, offer, opinion, counter-offer or acceptance. As the iteration process develops, a series of information directories are generated by the distributed system to map the information saved by each iteration cycle. The series of information directories are used as targets for the users to set the interoperability and for the users to subscribe to and access. Each directory has its own interoperable group, which is formed by the users who have subscribed to the according directory. A term-specified group of a specific directory is formed by users who have agreed to all the conditions/terms of the specific directory during the interoperation process; in other words, the term-specified group of the specific directory is formed by users who have reached convergence among their needs in the specific directory.

The method used to initiate the iteration process in the present invention is described below. First, a user defines a condition/term, and the system generates an information directory to collect the information of reciprocal interoperation. The information directory is owned by the user. The user can recruit other users of the system to join the directory through an administration module, in other words, the user may conduct advertising activities. When the other users have accessed the conditions/terms of the directory, interoperability is set for the specific directory, and the users subscribe to and are able to access the specific directory. Then, the users join the interoperable group of the directory, and the group members are able to provide feedback on the conditions/terms of the directory.

Through interoperation, inputs lead to feedbacks. Differences may exist between the input information and the feedback information. In the interoperation process of the present invention, the feedback information of a directory includes: accepting the input information with additional conditions/terms; or, partially modifying, partially accepting or declining the conditions/terms of the input information. A derivative information directory is generated when new conditions/terms are mutually exclusive with the conditions/terms of the input information. A user agent compares the new conditions/terms with the current conditions/terms for each user of the original directory. The results of the comparison are saved so that each member of the group can have access thereto.

The application of the present invention is not limited to transactions; however, in order to focus on the explanation of the present invention, only transaction is used as an example in the following description, and other applications of the present invention are omitted in the present disclosure. Besides, the term-specified group is represented by the parties involved in the transaction. Except for the dealers, the parties involved also include the third party who provides related services of transactions. The services provided by the third party may include target setting, transaction assurance, inspection, and the settlement of the funding and the target. The services provided by the third party are not limited to the ones mentioned above, and are defined as the conditions/terms of the transaction.

During the process of a transaction, the conditions/terms provided by the parties involved can be divided into different categories based on its features. For instance, the conditions/terms can be negotiable differences (e.g. difference in the price or amount), or can also be non-negotiable differences, which are mutually exclusive from each other (e.g. different targets). During the reciprocal interoperation process of the present invention, a derivative information directory is generated after new feedback information is provided for a directory. If the new conditions/terms are determined to be mutually exclusive from the old conditions/terms, the derivative information directory is created as a new branch information directory, and is used as a basic information directory to initiate subsequent reciprocal iteration.

A primary objective of the present invention is to provide a data processing system and method. The system and method provided is employed in a cloud environment of a distributed system to process/exchange information, thereby defining the basic information directory with conditions/terms for the specific subject matter. Reciprocal interoperation is performed on the basic information directory among the group members of an interoperable group so as to initiate directory iteration, generate derivative information directories, and generate interoperable groups of such directories and incident group composition change. In addition, for the basic information directory and/or derivative information directories related with specific subject matters, term-specified groups composed of users are formed, and terms of transaction are negotiated among group members of the term-specified group for the specific subject matter. That is, for the derivative information directories and/or basic information directory iterated based on the specific subject matter, the term-specified group is formed by users who have accessed and accepted all the condition/terms of the directories.

Another objective of the present invention is to provide a data processing system and method, which are employed in a cloud environment of a distributed system to process/exchange information. The system sets/generates the basic information directory based on the new conditions/terms defined by a first user in the parties involved, and/or based on the conditions/terms acquired from the internet or provided by the others in advance. The first user becomes a group member of the term-specified group of the basic information directory. A second user or other users may also join the term-specified group of the basic information directory by accessing the conditions/terms of the basic information directory, subscribing to the directory and setting the interoperability between each facility for the directory. If the second user does not accept all the conditions/terms of the basic information directory, the system may define new conditions/terms and thereby generating a new derivative information directory. The second user then becomes the group member of an interoperable group and the term-specified group of the derivative information directory. The other users who have joined the interoperable group of the basic information directory may also join the interoperable group of the derivative information directory simultaneously, or, may join the term-specified group of the derivative information directory and give up being the group member of the term-specified group of the basic information directory.

A further objective of the present invention is to provide a data processing system and method, in which the system sets the basic information directory based on the new conditions/terms defined by a first user from the parties involved, and/or based on the conditions/terms acquired from the internet or provided by the other in advance. The first user becomes a group member of an interoperable group and the term-specified group of the basic information directory. A second user may access the conditions/terms of the basic information directory, subscribe to the directory and set the interoperability between each facility for the directory to join the interoperable group of the basic information directory. If the second user accepts all the conditions/terms defined in the basic information directory, the second user joins the term-specified group of the basic information directory. If the second user does not accept all the conditions/terms defined in the basic information directory, the second user may define new conditions/terms, and the system can generate a new derivative information directory based on the new conditions/terms. The second user then becomes a group member of an interoperable group and a term-specified group of the derivative information directory. The new conditions/terms of the derivative information directory become an option for the group members of the interoperable group of the basic information directory. The group members of the interoperable group of the basic information directory are then invited to join the interoperable group of the derivative information directory. A user agent informs a master to send the new conditions/terms of the new derivative information directory to a worker module. In the mean time, the worker module inspects for the differences between the conditions/terms provided by the second user and the conditions/terms of the basic information directory. The result of the inspection is saved for later access for the first user and/or second user, or, the inspection result is pushed to the end of first user and/or second user by the worker module. The first user and/or the second user of the basic information directory may decide whether to join the interoperable group of the derivative information directory based on the new conditions/terms of the derivative information directory. The users are informed on the newest group composition of the interoperable group and the term-specified group after acquiring whether or not the first user and the other users joined the derivative information directory and whether or not they agreed to the conditions/terms thereof.

A further objective of the present invention is to provide a data processing system and method. The system may generate a new information directory based on the new conditions/terms acquired from the internet, and/or based on the new conditions/terms defined by a user from one of the interoperable groups of the current information directory. The new derivative information directory serves as the result of an iteration cycle among group members of the interoperable group, and also serves as the initial value of the next iteration cycle. For a specific directory in a series of information directories generated during the reciprocal iteration process, the user who creating it informs the group members of each interoperable group of the series of information directory via a worker module. Moreover, a user agent will be employed to pick up candidates from the rest of the system users and informs them via a worker module. The users of the systems, whom the user agent determines should inform, based on an analysis performed by the user agent, are also informed. The recruited system users subscribe to the specific directory, and set the interoperability between the facilities of group members for the directory so the users may access the directory. The subscribed users also become the message recipients of the directory, thereby forming the interoperable group of the information directory. Further reciprocal interoperation is performed for the conditions/terms. With the reciprocal interoperation among the users, iteration process of the conditions/terms is initiated, derivative information directory is further generated, and group composition change is incident.

A further objective of the present invention is to provide a data processing system and method. In the system and method provided, the system accepts the conditions/terms provided by a user of an interoperable group of the current information directory as feedback, which is provided based on the conditions/terms of the current information directory with additional conditions/terms. The system then processes the conditions/terms provided by the user. When the user provides feedback with additional conditions/terms, the user agent informs a master to send the additional conditions/terms and/or the conditions/terms of a new information directory to a worker module. The worker module then inspects and processes the additional conditions/terms and the original conditions/terms. Subsequently, the results of the inspection, which is the new information directory and the conditions/terms thereof, are saved for later access for the first user, second user and/or other users. As a result, the users may know if the transaction can be continued. As for a specific directory, the owner of the specific directory may recruit parties involved in the transaction to join the interoperable group through the master. Furthermore, the conditions/terms of the specific directory are considered as the conditions of the specific transaction. A term-specified group is then formed by parties involved who have agreed to all the conditions/terms, thereby allowing transaction.

A further objective of the present invention is to provide a data processing system and method. In the system and method provided, the owner of a directory may recruit other non-specified system users to join an interoperable group thereof, and to further perform reciprocal iteration and accumulation of their opinions, such as the conditions/terms of the transaction. In this way, the group members may discard their difference and reach convergence in their needs. The mutually exclusive needs are separated to generate another new information directory for further interoperation. As a result, different parties involved in the transaction (e.g. individual users or groups) may further interoperate during the negotiation process, and the negotiation results can be accumulated gradually to complete the transaction.

For achieving the foregoing objectives, the present invention provides a data processing system. The data processing system of the present invention includes an administration module, a storage module and at least one worker module.

The administration module of the present invention includes a master and a user agent.

The storage module of the present invention is used to store the information directories, derivative information directories and process results.

The execution of the at least one worker module is decided by the master of the administration module. When a first user from the parties involved in the transaction set/generate the conditions/terms of a basic information directory based on the conditions/terms defined by the first user, and/or acquired from the internet or defined by the others in advance, the first user becomes a group member of a term-specified group of the basic information directory. The basic information directory is then saved in the storage module. A second user and other users may subscribe to the directory and set the interoperability between the facilities of the directory form an interoperable group based on specific conditions/terms thereof, which has access to the basic information directory. If the second user and other users accept all the conditions/terms of the basic information directory, the second user and other users become group members of the term-specified group and are allowed to perform transaction in the basic information directory. If the second user does not accept all the conditions/terms defining the basic information directory, the second user may provide new conditions/terms to generate a derivative information directory. The second user then becomes a group member of an interoperable group and a term-specified group of the derivative information directory. The derivative information directory generated is also saved in the storage module. Herein, the new conditions/terms of the derivative information directory become an option of the basic information directory. The other users in the term-specified group of the basic information directories may subscribe to the directory and become group members of the interoperable group of the directory, which has access to the derivative information directory simultaneously, or, may accept all the conditions/terms to become group members of the term-specified group, and give up being in the term-specified group of the basic information directory.

The user agent of the administration module informs the master to send the new conditions/terms of the new derivative information directory to the worker module, then; the worker module sends the new conditions/terms of the derivative information directory to the first user and other users. In the mean time, the worker module inspects the conditions/terms provided by the second user to make sure they comply with the conditions/terms of the basic information directory. The process results from the inspection are then saved for later access for the first user and/or other users. Alternatively, the process results from the inspection are pushed to the end of first user and/or other users.

The first user and/or other users of the basic information directory may decide whether to subscribe to the derivative information directory, to set the interoperability between the facilities of the directories, and to become group members of the interoperable group based on specific conditions/terms based on the new conditions/terms of the derivative information directory. When the first user, second user and other users accept all the conditions/terms of a specific information directory, the users are informed on the newest group composition of the term-specified group.

When processing data with the data processing system provided by the present invention, first, basic information directory is set. Herein, the basic information directory is set with conditions/terms for a specific subject matter, and cloud computing architecture is used when processing the basic information directory.

Next, repeated action is performed. Herein, reciprocal interoperation is performed on the basic information directory between users, so as to initiate directory iteration, generate derivative information directories and incident group composition change. For example, after a first user sets the conditions/terms of the basic information directory, the second user subscribes to the directory, sets the interoperability between the facilities of the directory, and becomes a group member of the interoperable group based on specific conditions/terms, if a second user does not accept all the conditions/terms thereof, the second user defines new conditions/terms to generate a new derivative information directory and becomes a group member of a interoperable group and a term-specified group of the derivative information directory. The user agent informs the master to send the new conditions/terms of the derivative information directory provided by the second user to the worker module, and the worker module sends the new conditions/terms to the other users. The user agent serves to manage the worker module. The worker module inspects the conditions/terms of the information directories. Herein, the worker module inspects the conditions/terms of the derivative information directory provided by the second user to make sure they comply with the conditions/terms of the basic information directory. In the mean time, the process results from the inspection are saved for later access for the first user and/or other users. Alternatively, the process results from the inspection are pushed to the end of first user or other users. The first user and/or other users of the basic information directory may decide whether to subscribe to the derivative information directory and to become group member of the interoperable group.

Last, a term-specified group composed of users is formed for a specific subject matter. Herein, the term-specified group composed of users is formed for the basic information directory and/or derivative information directory related to the specific subject matter. Terms of transaction are negotiated between users for the specific subject matter, that is, for the derivative information directories generated during the reciprocal iteration process, and/or the basic information directories related to the specific subject matter, the term-specified group is formed composed of users who have read/review and accepted all the conditions/terms of the directory. For example, when the first user, second user and other users accept the conditions/terms of the specific information directory, users are informed on the newest group composition of the term-specified group.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating the architecture and the operation of a data processing system provided by the present invention;

FIG. 2 is a flow diagram showing the steps of a data processing method of the present invention using the data processing system illustrated in FIG. 1;

FIG. 3 is a schematic diagram illustrating a first operation of the step of performing reciprocal interoperation in FIG. 2;

FIG. 4 is a schematic diagram illustrating a second operation of the step of performing reciprocal interoperation in FIG. 2;

FIG. 5 is a schematic diagram illustrating a third operation of the step of performing reciprocal interoperation in FIG. 2;

FIG. 6 is a schematic diagram illustrating a fourth operation of the step of performing reciprocal interoperation in FIG. 2;

FIG. 7 is a schematic diagram illustrating a fifth operation of the step of performing reciprocal interoperation in FIG. 2;

FIG. 8 is a schematic diagram illustrating a sixth operation of the step of performing reciprocal interoperation in FIG. 2;

FIG. 9 is a schematic diagram illustrating a seventh operation of the step of performing reciprocal interoperation in FIG. 2;

FIG. 10 is a schematic diagram illustrating the operation of the data processing system according to a first embodiment of the present invention;

FIG. 11 is a flow diagram showing the steps of the data processing method according to the first embodiment using the data processing system illustrated in FIG. 10;

FIG. 12 is a schematic diagram illustrating the operation of the data processing system according to the present invention according to a second embodiment; and

FIG. 13 is a flow diagram showing the steps of the data processing method according to the second embodiment using the data processing system illustrated in FIG. 12.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

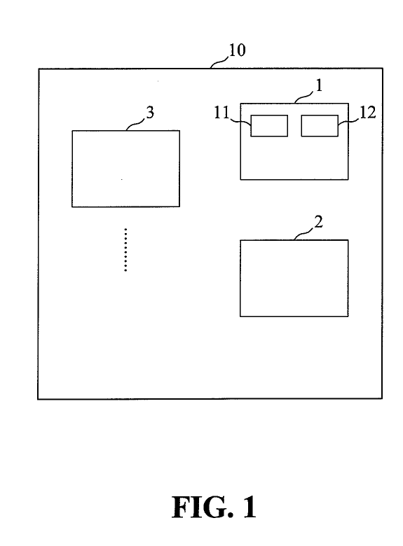

FIG. 1 is a schematic diagram illustrating the architecture and the operation of a data processing system disclosed in the present invention. As shown in FIG. 1, the data processing system 10 includes an administration module 1, a storage module 2 and at least one worker module 3. Herein, the data processing system 10 is located at a cloud server (not shown).

The administration module 1 includes a master 11 and a user agent 12.

The storage module 2 is used to store information directories (not shown) and process results (not shown).

The operation and execution of the at least one worker module 3 is decided by the master 11 of the administration module 1. A first user in the parties involved in the transaction sets/generates a first basic information directory (e.g. real estate buying information directory, or real estate selling information directory) and the conditions/terms thereof (e.g. the conditions/terms of the buyer, or the conditions/terms of the seller) based on the conditions/terms defined by the first user, or, based on the conditions/terms acquired from the internet and/or defined by a third party in advance. The first user becomes a group member of a term-specified group of the first basic information directory, and the first basic information directory is saved in the storage module 2. If a second user and other users subscribe to the directory, set the interoperability between the facilities of the directory, the second user and other users become group members of the interoperable group, which has access to the first basic information directory. If a second user and other users accept all the conditions/terms of the first basic information directory, they may join and become the group members of the term-specified group of the basic information directory, and are given access to the first basic information directory. If the second user does not accept all the conditions/terms of the first basic information directory, the second user may provide new conditions/terms and initiate iteration process on the first basic information directory, thereby generating a new derivative information directory. Then, the second user becomes a group member of an interoperable group and a term-specified group of the derivative information directory, and the derivative information directory is saved in the storage module 2. Herein, the new conditions/terms of the derivative information directory become an option of the first basic information directory. The other users of the term-specified group of the first basic information directory may join the interoperable group, which has access to the derivative information directory, or, may accept new conditions/terms to become group members of a term-specified group of the derivative information directory; alternatively, the other users may join the interoperable group, which has access to the derivative information directory, or accept new conditions/terms to become group members of the term-specified group of the derivative information directory and give up being in the term-specified group of the first basic information directory.

The user agent 12 of the administration module 1 informs the master to send the new conditions/terms of the new derivative information directory from storage module 2 to the worker module 3. The worker module 3 then sends the new conditions/terms of the derivative information directory to the first user and other users. Meanwhile, the worker module 3 inspects the conditions/terms of the derivative information directory to see if they comply with the conditions/terms of the first basic information directory. The process result from the inspection is sent to and saved in the storage module 2 for later access for the first user and other users, or the process result is pushed to the first user end and/or other user ends.

The first user and/or other users of the first basic information directory may decide whether to join the derivative information directory based on the new conditions/terms of the derivative information directory, which is an option for the first basic information directory, and becomes group members of an interoperable group having access to the derivative information directory. When the first user, second user and other users make the decision, that is, whether or not to accept all the conditions/terms of the term-specified group, the users are informed on the newest group composition of the term-specified group.

The basic information directory and/or the derivative information directory are, for example, at least one real estate selling information directory and/or at least one real estate buying information directory, the conditions/terms of at least one real estate selling information directory that are related to the conditions/terms of the seller in a real estate transaction, and/or, the conditions/terms of at least one real estate buying information directory that are related to the conditions/terms of the buyer in a real estate transaction. In addition, the first user, second user and other users can be the buyer and/or seller in a real estate transaction, depending on the situation.

Herein, after the user sets an information directory, new derivative information directories can be generated from the original information directory based on the new conditions/terms defined by other users. For one specific directory in the new information directory, and/or the information directories generated in the process of reciprocal iteration, a term-specified group is formed based on the conditions/terms of the specific directory among the users who subscribe to and have accepted the conditions/terms of the specific directory. Parties involved in the transaction are recruited through the master 11, and conditions of the transaction are settled according to the conditions/terms of the specific directory. In this way, a term-specified group is formed, thereby allowing transaction.

Alternatively, users may iterate information directories and/or accumulate new information directories according to the newly defined conditions/terms based on the original information directory. An interoperable group of the information directory may be formed among non-specific users of the system, and interoperability between facilities of group members can be set. When processing the information directories defined by the group members, the user agent 12 informs the master 11 to send the conditions/terms defined by the users, the information directories generated during the reciprocal iteration process, and/or the conditions/terms of the new information directories to the worker module 3 after an user updates the conditions/terms of the information directory. Meanwhile, the worker module 3 is informed to process related information directories. The process results are saved for later access for the users, so the users can have information on the newest group members of the term-specified group. For one specific directory, a term-specified group is formed based on the conditions/terms of the specific directory among users who subscribe to and have accepted all the conditions/terms of the specific directory. Parties involved in the transaction are recruited through the master 11, and conditions of the transaction are settled according to the conditions/terms of the specific directory. In this way, a term-specified group is formed, thereby allowing transaction.

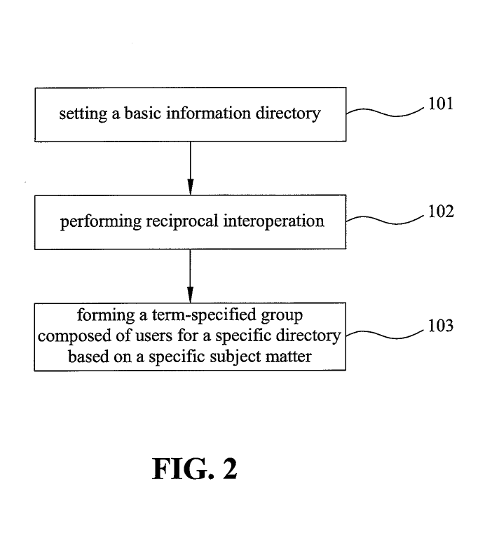

FIG. 2 is a flow diagram showing the steps of a data processing method using the data processing system shown in FIG. 1. As shown in FIG. 2, first, in step 101, a first basic information directory is set. Herein, the first basic information directory is defined with conditions/terms for a specific subject matter. When processing the first basic information directory, cloud computing architecture is used. In addition, the master 11 of administration module 1 decides the execution and operation of the worker module 3 in step 101. After step 101, the data processing method of the present invention proceeds to step 102.

In step 102, reciprocal interoperation is performed. Herein, reciprocal interoperation is performed on the first basic information directory between users to initiate directory iteration, generate derivative information directories and incident group composition changes. After step 102, the data processing method of the present invention proceeds to step 103.

For example, in step 102, if the second user does not accept all the conditions/terms of the first basic information directory set by the first user, the second user may provide new conditions/terms to initiate iteration process on the first basic information directory and generate a new derivative information directory. The second user becomes a group member of the interoperable group and the term-specified group of the derivative information directory. The user agent 12 of the administration module 1 informs the master to send the new conditions/terms of the subdirectory provided by the second user to the worker module 3, then, the worker module 3 sends the new conditions/terms to the other users. Meanwhile, the user agent 12 manages the worker module 3, and the worker module inspects the conditions/terms of the information directories. Herein, the worker module 3 inspects the conditions/terms of the derivative information directory provided by the second user to see if they comply with the conditions/terms of the first basic information directory. The process result from inspection is saved for later access for the first user and/or other users; alternatively, the process result is pushed to the first user end and/or other user ends. The first user and/or other users in the first basic information directory may decide whether to subscribe to the derivative information directory based on the new conditions/terms of the derivative information directory, which is an option of the first basic information directory, or further become group members of the term-specified group of the derivative information directory.

In step 103, a term-specified group composed of users is formed based on a specific subject matter. Herein, the term-specified group composed of users is formed for the basic information directory and/or derivative information directories related to the specific subject matter. Terms of transaction is negotiated between users based on the specific subject matter, that is, for the derivative information directory generated during the reciprocal iteration process, and/or for the basic information directory related to the specific subject matter, term-specified group is formed by users who have reviewed/read and accepted all the conditions/terms of the directory. For example, when the first user, the second user and other users accept the condition/terms of a specific information directory, they are informed on the newest group composition of the term-specified group.

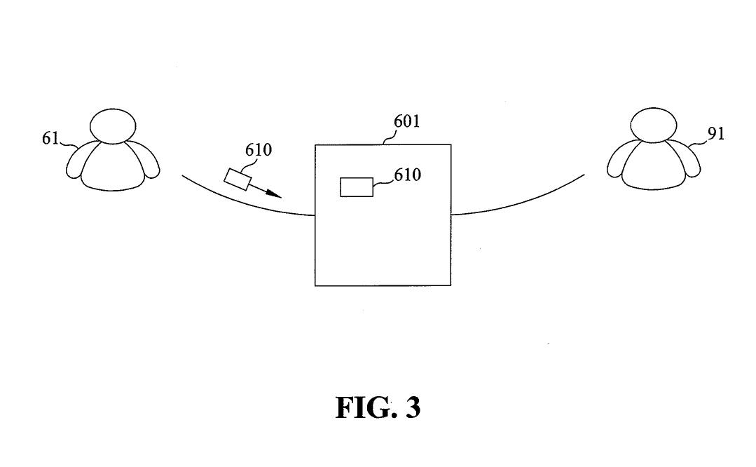

FIG. 3 is a schematic diagram illustrating a first operation of the step of performing repeated action in FIG. 2. As shown in FIG. 3, at least one second user 91 accepts the conditions/terms 610 of the first basic information directory 601 provided by the first user 61. The at least one second user 91 becomes the member of the term-specified group of the first basic information directory 601, and is allowed to perform transaction with the first user 61 and/or other group members in the first basic information directory 601. After the second user 91 joins the first basic information directory 601, if the group member limit in the first basic information directory 601 is not reached, or a limit is not set on the number of the group members of the first basic information directory 601, other at least one user may also become a group member of the term-specified group of the first basic information directory 601 to perform transaction therein under the conditions/terms 610.

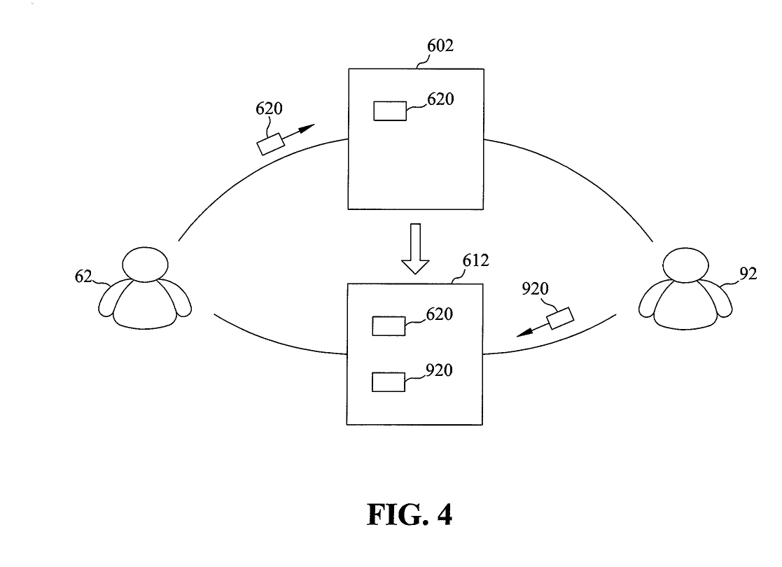

FIG. 4 is a schematic diagram illustrating a second operation of the step of performing repeated action in FIG. 2. As shown in FIG. 4, a second user 92 accepts the conditions/terms 620 of the first basic information directory 602 provided by a first user 62. The second user 92 becomes a group member of the term-specified group of the first basic information directory 602, and is able to perform transaction in the first basic information directory 602. Yet, the second user 92 adds conditions/terms 920 to be an option of the first basic information directory 602. A derivative information directory 612 is generated, and the second user 92 becomes a group member of the term-specified group of the derivative information directory 612. The group members of the interoperable group of the first basic information directory 602 are informed to decide whether to subscribe to the derivative information directory 612 to become a group member of the interoperable group thereof, or further to become a group member of the term-specified group of the derivative information directory 612 to perform transaction therein. The first user 62, the second user 92 and/or the other users may add conditions/terms during the repeated process of accepting the conditions/terms provided by the other users, thereby generating new derivative information directories. For the derivative information directories and/or basic information directories generated related to a specific subject matter, a term-specified group is formed by users who have accessed and accepted all the conditions/terms of the directory.

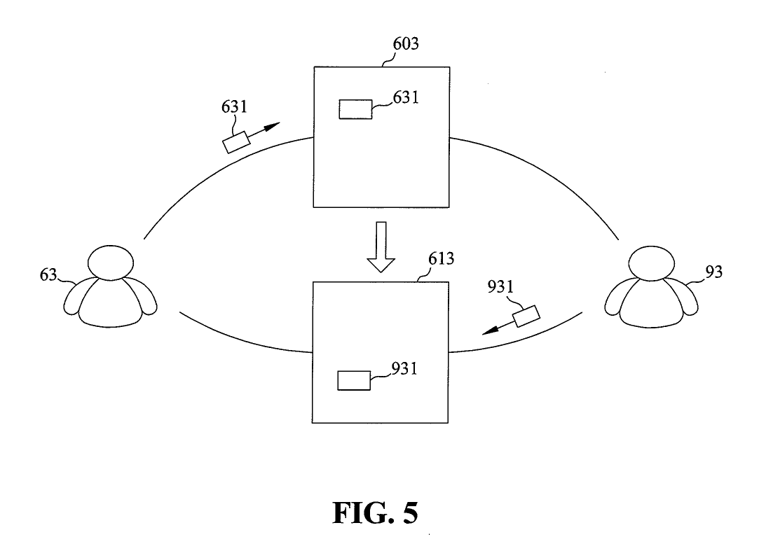

FIG. 5 is a schematic diagram illustrating a third operation of the step of performing repeated action in FIG. 2. As shown in FIG. 5, a second user 93 partially modifies, partially accepts or declines the conditions/terms 631 of the first basic information directory 603 provided by a first user 63. Meanwhile, the second user 93 provides conditions/terms 931 to be an option for the first basic information directory 603. A derivative information directory 613 is generated, and the second user 93 becomes a group member of the term-specified group of the derivative information directory 613. The group members of the interoperable group of the first information directory 603 are informed to decide whether to subscribe to the derivative information directory 613 to become group members of the interoperable group thereof, or further to become group member of the term-specified group of the derivative information directory 613 to perform transaction therein. The first user 63, the second user 93 and/or the other users may add conditions/terms during the repeated process of partially modifying, partially accepting or declining the conditions/terms provided by the other users, thereby generating new derivative information directories. For the derivative information directories and/or basic information directories generated related to a specific subject matter, a term-specified group is formed by users who have reviewed/read and accepted all the conditions/terms of the directory.

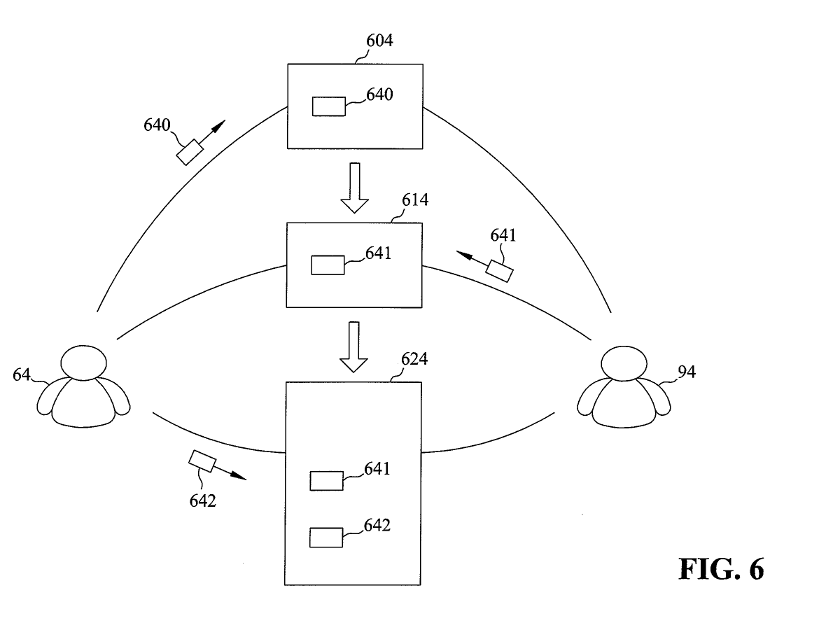

FIG. 6 is a schematic diagram illustrating a fourth operation of the step of performing repeated action in FIG. 2. As shown in FIG. 6, a second user 94 accepts the conditions/terms 640 of the first basic information directory 604 provided by a first user 64. The second user 94 becomes a group member of the term-specified group of the first information directory 604, and is able to perform transaction therein. Yet, the second user 94 provides conditions/terms 641 to be an option of the first basic information directory 604, in which the conditions/terms 641 are modified based on the conditions/terms 640. A derivative information directory 614 is generated, and the second user 94 becomes a group member of the term-specified group of the derivative information directory 614. The group members of the interoperable group of the first basic information directory 604 are informed to decide whether to subscribe to the derivative information directory 614 to become group members of the interoperable group thereof, or further to become group members of the term-specified group of the derivative information directory 614 to perform transaction therein. Then, the first user 64 provides new conditions/terms 642 to be an option of the derivative information directory 614, thereby generating a derivative information directory 624. The first user 64 becomes a group member of the term-specified group of the derivative information directory 624. After the second user 94 accepts the new conditions/terms 642, the second user 94 also becomes a group member of the term-specified group of the derivative information directory 624, and is able to perform transaction in the derivative information directory 624. The group members of the interoperable group of the first basic information directory 604 and the interoperable group of the derivative information directory 614 are informed to decide whether to subscribe to the derivative information directory 624 to become group members of the interoperable group thereof, or further to become group members a the term-specified group of the derivative information directory 624.

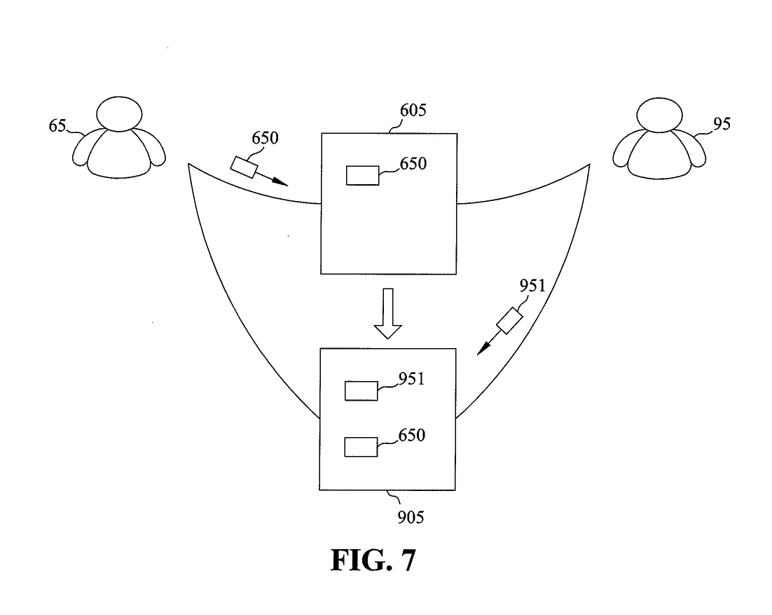

FIG. 7 is a schematic diagram illustrating a fifth operation of the step of performing repeated action in FIG. 2. As shown in FIG. 7, a second user 95 accepts the conditions/terms 650 of the first basic information directory 605 provided by a first user 65. The second user 95 becomes a group member of the term-specified group of the first information directory 605, and is able to perform transaction therein. Yet, the second user 95 defines a new second basic information directory 905 based on the first basic information directory 605 (including condition/terms 650) with conditions/terms 951. The second user 95 becomes a group member of the term-specified group of the second basic information directory 905. In this way, the second basic information directory 905 includes the conditions/terms 650 and the conditions/terms 951.

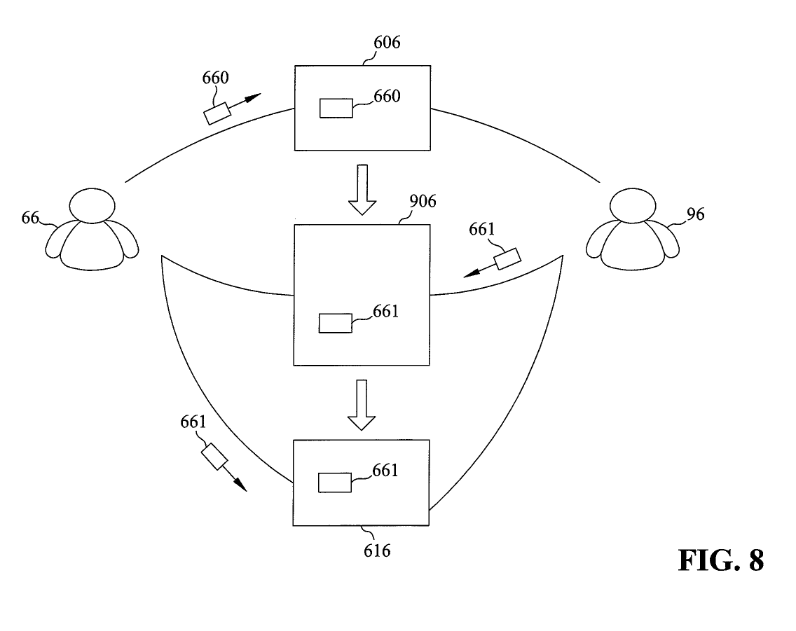

FIG. 8 is a schematic diagram illustrating a sixth operation of the step of performing repeated action in FIG. 2. As shown in FIG. 8, a second user 96 accepts the conditions/terms 660 of the first basic information directory 606 provided by a first user 66. The second user 96 becomes a group member of the term-specified group of the first information directory 606, and is able to perform transaction therein. Yet, the second user 96 provides condition/terms 661 modified from the conditions/terms 660 to be an option of the first basic information directory 606. A derivative information directory 906 is generated, and the second user 96 becomes a group member of the term-specified group of the derivative information directory 906. The group members of the interoperable group of the first basic information directory 606 are informed to decide whether to subscribe to the derivative information directory 906 to become group members of the interoperable group thereof, or further to become group members of the term-specified group of the derivative information directory 906 to perform transaction therein. Hence, the first basic information directory 606 includes the conditions/terms 660, and the derivative information directory 906 includes the conditions/terms 661. In addition, a second derivative information directory 616 is generated by the first user 66 based on the derivative information directory 906, therefore, the second derivative information directory 616 only includes the conditions/terms 661.

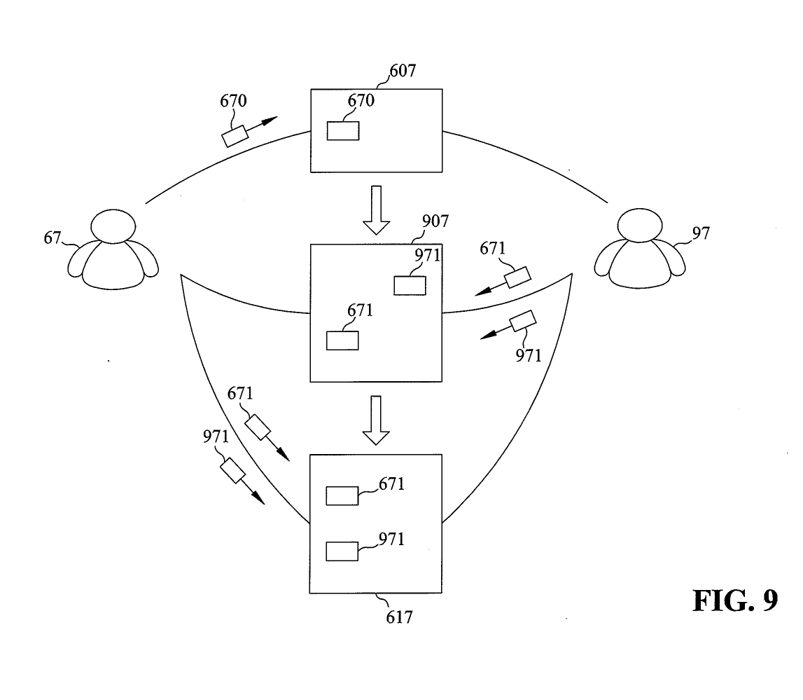

FIG. 9 is a schematic diagram illustrating a seventh operation of the step of performing repeated action in FIG. 2. As shown in FIG. 9, a second user 97 accepts the conditions/terms 670 of the first basic information directory 607 provided by a first user 67. The second user 97 becomes a group member of the term-specified group of the first information directory 607, and is able to perform transaction therein. Yet, the second user 97 provides condition/terms 907 modified from the conditions/terms 670. In addition, the second user 97 also provides the new conditions/terms 971 to be options of the first basic information directory 607. The second user 97 becomes a group member of the term-specified group of a derivative information directory 617. The group members of the interoperable group of the first basic information directory 607 are informed to decide whether to subscribe to the derivative information directory 907 to become group members of the interoperable group thereof, or further to become group members of the term-specified group of the derivative information directory 907 to perform transaction therein. Hence, the first basic information directory 607 includes the conditions/terms 670, and the derivative information directory 907 includes the conditions/terms 671 and the conditions/terms 971. Also, a second derivative information directory 617 is generated by the first user 67 based on the derivative information directory 907, so the second derivative information directory 617 includes the conditions/terms 671 (modified from the conditions/terms 670) and the conditions/terms 971 (defined by the second user 97).

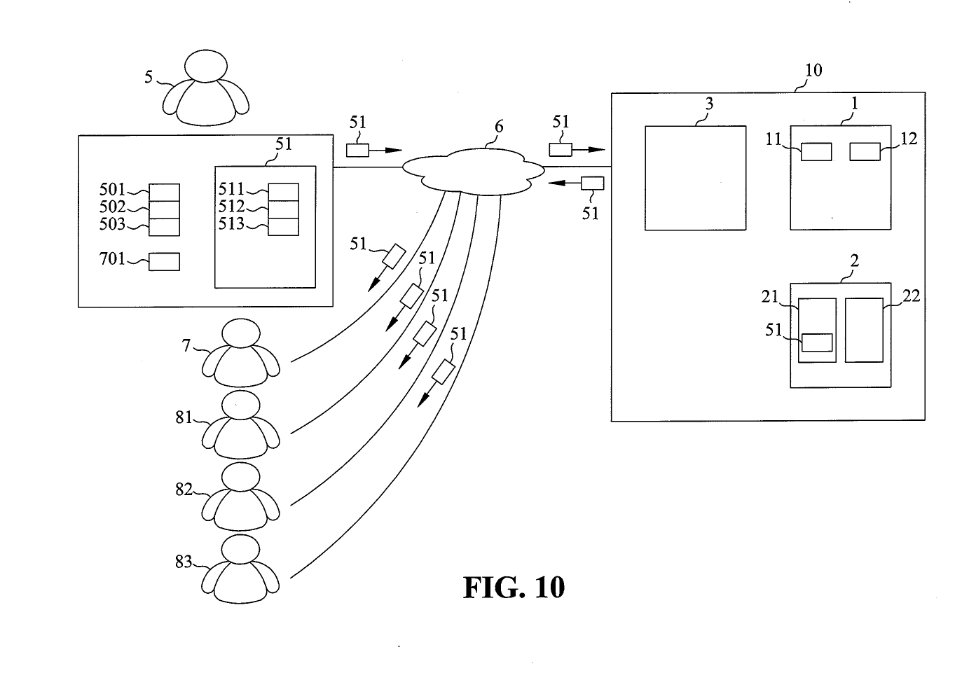

FIG. 10 is a schematic diagram illustrating the operation of the data processing system according to a first embodiment of the present invention. As shown in FIG. 10, the data processing system 10 includes an administration module 1, a storage module 2 and at least one worker module 3. Herein, the data processing system 10 can be located at a cloud server.

The administration module 1 includes a master 11 and a user agent 12.

The storage module 2 is used to store an information directory 21 and process result 22. Herein, the information directory 21 includes a first basic information directory 51, and the process result 22 is the transaction result after a transaction.

The master 11 of the administration 1 decides the execution and operation of the at least one worker module 3. A first user 5 (e.g. the buyer or seller in a real estate transaction) from the parties involved in the transaction sets/generates a first basic information directory 51 (e.g. real estate buying/selling information directory) and the conditions/terms 511, 512 and 513 included therein based on the conditions/terms 501, 502 and 503 defined by the first user 5, and/or, based on the conditions/terms 701 acquired from the internet 6 or defined by a third party (e.g. the buyer or seller in a real estate transaction) in advance. The first user 5 then becomes a group member of a term-specified group of the first basic information directory 51, and is able to save the first basic information directory 51 (e.g. real estate buying/selling information directory) in the storage module 2 for access for the worker module 3. The second user 7 and other users 81, 82 and 83 accept all the conditions/terms 511, 512 and 513, so as to join and become the group members of the term-specified group of the first basic information directory 51 and acquire access thereto.

The first information directory 51 can be at least one real estate selling information directory and/or at least one real estate buying information directory, the conditions/terms of at least one real estate selling information directory which is related to the conditions/terms of the seller in a real estate transaction, and/or, the conditions/terms of at least one real estate buying information directory which is related to the conditions/terms of the buyer in a real estate transaction. In addition, the first user 5, the second user 7 and/or other users 81, 82 and 83 can be the buyer and/or seller in a real estate transaction, depending on the actual situation.

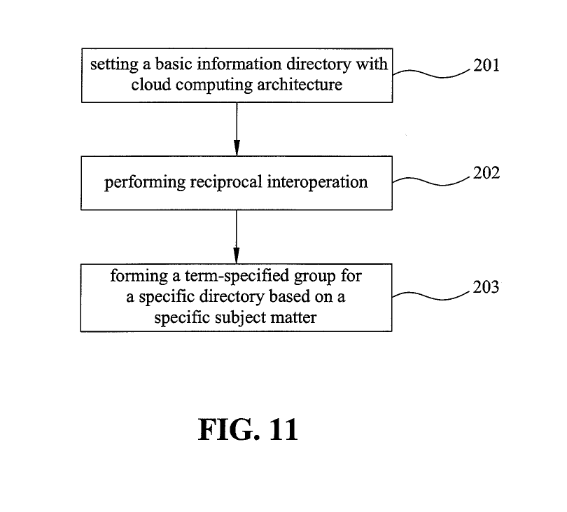

FIG. 11 is a flow diagram showing the steps of the data processing method according to the first embodiment using the data processing system illustrated in FIG. 10. As shown in FIG. 11, in step 201, the first basic information directory 51 is set. Herein, the first user 5 defines the conditions/terms 511, 512 and 513 of the first basic information directory 51 according to a specific subject matter. When processing the basic information directory, a cloud computing architecture is used. After performing step 201, the method according to the present invention then proceeds to step 202.

In step 201, the master 11 of the administration module 1 decides the execution and operation of the worker module 3. The first user 5 (e.g. the buyer or seller in a real estate transaction) from the parties involved in the transaction sets/generates the first basic information directory 51 and the conditions/terms 511, 512 and 513 included therein based on the new conditions/terms 501, 502 and 503 defined by the first user, and/or, based on the conditions/terms 701 acquired from the internet 6 or defined by a third party (e.g. the buyer or seller in a real estate transaction) in advance. The first user 5 then becomes a group member of the term-specified group of the first basic information directory, and the first basic information directory 51 is saved in the storage module 2.

In step 202, reciprocal interoperation is performed. Herein, reciprocal interoperation is performed on the first basic information directory 51 among the users, so as to initiate directory iteration, generate derivative information directories and incident group composition changes. After performing step 202, the data processing method according to the present invention then proceeds to step 203.

In step 202, worker module 3 accesses the first basic information directory 51. The second user 7 and the other users 81, 82 and 83 accept all the conditions/terms 511, 512 and 513 in the first basic information directory 51.

In step 203, a term-specified group is formed by the users 5, 7, 81, 82 and 83 according to the specific subject matter. Herein, for the first basic information directory 51 related to the specific subject matter, the term-specified group is formed by users 5, 7, 81, 82 and 83. Terms of transaction is negotiated between users based on the specific subject matter, that is, for the first basic information directory 51 related to the specific subject matter, the term-specified group is formed by users 5, 7, 81, 82 and 83 who have reviewed/read and accepted all the conditions/terms 511, 512 and 513 of the first basic information directory 51.

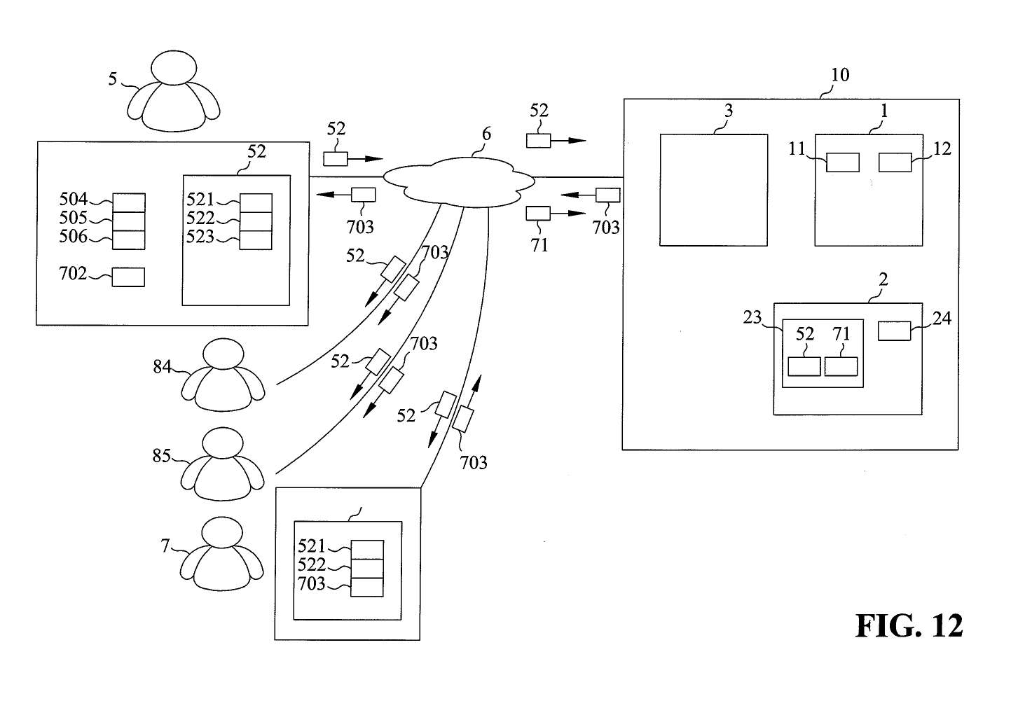

FIG. 12 is a schematic diagram illustrating the operation of the data processing system according to the present invention according to a second embodiment. As shown in FIG. 12, the data processing system 10 includes an administration module 1, a storage module 2 and at least one worker module 3. The data processing system 10 is located in a cloud server.

The administration module 1 includes a master 11 and a user agent 12.

The storage module 2 is used to store an information directory 23 and process result 24. Herein, the information directory 23 includes a first basic information directory 52 and a second basic information directory 71.

The master 11 of the administration 1 decides the execution and operation of the at least one worker module 3. A first user 5 (e.g. the buyer or seller in a real estate transaction) from the parties involved in the transaction sets/generates a first basic information directory 51 (e.g. real estate buying/selling information directory) and the conditions/terms 521, 522 and 523 included therein based on the conditions/terms 501, 502 and 503 defined by the first user 5, and/or, based on the conditions/terms 701 acquired from the internet 6 or defined by a third party (e.g. the buyer or seller in a real estate transaction) in advance. The first user 5 then becomes a group member of a term-specified group of the first basic information directory 51, and is able to save the first basic information directory 51 (e.g. real estate buying/selling information directory) in the storage module 2 for access for the worker module 3. The other users 84 and 85 accept all the conditions/terms 521, 522 and 523, so as to join and become the group members of the term-specified group of the first basic information directory 51 and acquire access thereto. Yet, if the second user 7 does not accept all the conditions/terms 521, 522 and 523 in the first basic information directory 52, for example, if the second user 7 only accepts the conditions/terms 521 and 522 and does not accept the conditions/terms 523, then, the second user 7 provides new conditions/terms 703, and initiates iteration process on the first basic information directory 52, thereby generating a second basic information directory 71 (e.g. real estate buying/selling information directory) including the conditions/terms 521, 522 and 703. The second user then becomes a group member of the term-specified group of the second basic information directory 71, and is able to save the second basic information directory 71 in the storage module 2. Herein, the new conditions/terms 703 (e.g. the terms of transactions provided by the buyer/seller) of the second basic information directory 71 become an option of the first basic information directory 52.

The user agent 12 of the administration module 1 informs the master 11 to send the new conditions/terms 703 of the second basic information directory 71 from the storage module 2 to the worker module 3. Then, the worker module 3 sends the new conditions/terms 703 to the first user 5 and other users 84 and 85. Being the group members of the term-specified group of the first basic information directory 52, the first user 5 and other users 84 and 85 may subscribe to the interoperable group having access to the second basic information directory 71 simultaneously, or, further become the term-specified group of the second basic information directory 71; or, the other users 84 and 85 may join the interoperable group having access to the second basic information directory 71, or further become group members of the term-specified group of the second basic information directory, and give up being in the term-specified group of the first basic information directory 52.

The worker module 3 inspects the conditions/terms (521, 522 and 703) of the second basic information directory 71 provided by the second user 7 to see if they comply with the conditions/terms (521, 522 and 523) of the first basic information directory. The process result 24 from the inspection is then sent to and saved in the storage module 2 for later access for the first user 5 and/or other users 84 and 85. Alternatively, the process result 24 is pushed to the first user 5 and/or other users 84 and 85.

The first user 5 and/or other users 84 and 85 in the first basic information directory 52 may decide whether to subscribe to the second basic information directory 71 and becomes group members of the interoperable groups having access to the second basic information directory 71 based on the new conditions/terms 703 of the second basic information directory 71. When the first user 5, second user 7 and other users 84 and 85 make their decision, the users are informed on the newest group composition of the term-specified group.

The first basic information directory 52 and/or the second basic information directory 71 can be at least one real estate selling information directory and/or at least one real estate buying information directory, the conditions/terms of at least one real estate selling information directory which is related to the conditions/terms of the seller in a real estate transaction, and/or, the conditions/terms of at least one real estate buying information directory which is related to the conditions/terms of the buyer in a real estate transaction. In addition, the first user 5, second user 7 and/or other users 81, 82 and 83 can be the buyer or selling in a real estate transaction, depending on the actual situation.

Herein, after an information directory is set by a user, the information directory can generate new information directories based on the new conditions/terms defined by users. For a specific directory among the information directories generated by the reciprocal iteration process and/or new information directories, a term-specified group which follows the conditions/terms of the specific directory is formed by users who subscribe to and accept the conditions/terms of the specific directory. Parties involved in the transaction are recruited through the master 11. A term-specified group is formed with conditions of transaction according to the conditions/terms of the specific directory, thereby allowing transaction.

Alternatively, users may initiate iteration process on information directory and/or accumulate new information directory based on the original information directory and newly defined conditions/terms, meanwhile, the interoperability between facilities of group members can be set for the directory. When processing the information directories defined by non-specific users of the system, the user agent 12 informs the master 11 to send conditions/terms defined by users, information directories generated by iteration process and/or conditions/terms of new information directories to the worker module 3 after users update the conditions/terms of information directories. The worker module 3 is then informed to process related information directories and to save the process result for later access, in this way, when users decide whether to accept the conditions/terms of the specific information directory, users may know the newest group composition of the term-specified groups. For a specific directory, a term-specified group is formed based on the conditions/terms of the specific directory by users who subscribe to and accept the conditions/terms of the specific directory. Parties involved in the transaction are recruited through the master 11. A term-specified group is formed with conditions/terms of the transaction according to the conditions/terms of the specific directory, thereby allowing transaction.

In addition, the buyers and sellers in a transaction both agree to the abovementioned conditions of interaction, so opinions of the buyers and sellers (e.g. individuals or groups) can be accumulated during the process of reciprocal interoperation. For example, conditions/terms of the buyers and the sellers can be accumulated, so as to eliminate the difference between the sellers and buyers and to reach convergence among the different needs of the parties involved. The mutually exclusive needs are branched out to generate a new information directory for further interaction. In this way, negotiation process is opened to the buyers and sellers (e.g. individuals or groups) and opinions from both sides can be collected repeatedly, thereby accumulating negotiation results so as to complete the transaction.

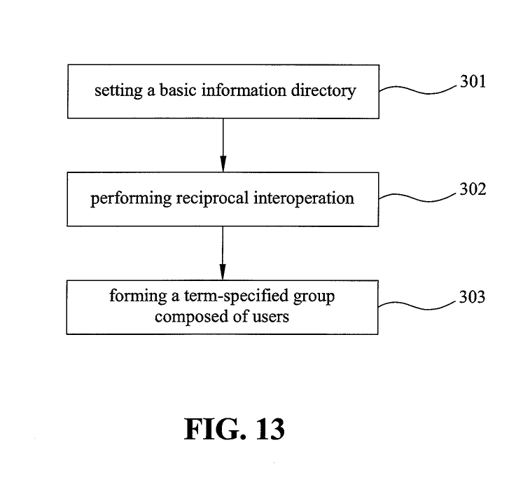

FIG. 13 is a flow diagram showing the steps of the data processing method according to the second embodiment using the data processing system illustrated in FIG. 12. As shown in FIG. 13, first, the first basic information directory 52 is set in step 301. Herein, the first user 5 defines the first basic information directory 52 with conditions/terms 521, 522 and 521. When processing the first basic information directory 52, a cloud computing architecture is used. After step 301, the data process method according to the present invention proceeds to step 302.

In step 301, the master 11 of the administration module 1 decides the operation and execution of the worker module 3. The first user 5 (e.g. the buyer/seller in a real estate transaction) from the parties involved in the transaction sets/generates the first basic information directory 52 (e.g. real estate buying/selling information directory) and the conditions/terms 521, 522 and 523 (conditions/terms of transaction of the buyer/seller) included therein based on the new conditions/terms 504, 504 and 506 defined by the first user 5, and/or based on the conditions/terms 602 acquired from the internet 6 or defined by a third party (e.g. the buyer/seller in a real estate transaction) in advance. The first user 5 becomes a group member of the term-specified group of the first basic information directory 52 (e.g. real estate buying/selling information directory), and is able to save the first basic information directory 52 in the storage module 2.

In step 302, reciprocal interoperation is performed. Herein, reciprocal interoperation is performed on the first basic information directory between users, so as to initiate directory iteration, generate the second basic information directory 71 and accompany group member change. After performing step 302, the data processing method according to the second embodiment of present invention proceeds to step 303.

In step 302, the worker module 3 accesses the first basic information directory 52. Other users 84 and 85 may accept all the conditions/terms 521, 522 and 523 of the first basic information directory 52 to join the term-specified group of the first basic information directory 52 and gain access thereto. Yet, if the second user 7 does not accept all the conditions/terms of the first basic information directory 52, the second user 7 may provide new conditions/terms 703 defined by the second user 7 and iterate the first basic information directory 52, thereby generating the new second basic information directory 71. The second user then becomes the group member of term-specified group of the second basic information directory 71. The user agent 12 of the administration module 1 informs the master 11 to send the new conditions/terms 703 of the second basic information directory 71 provided by the second user 7 to the worker module 3, and, the worker module 3 sends the new conditions/terms 703 to the first user 5 and other users 84 and 85.

In step 303, worker module 3 inspects the conditions/terms of the information directories. Herein, the worker module 3 inspects the conditions/terms (521, 522 and 703) of the second basic information directory 71 provided by the second user 7 to see if they comply with the conditions/terms (521, 522 and 523) of the first basic information directory 52. The process result 24 from the inspection is sent to and saved in the storage module 2 for later access for the first user 56 and/or other users 84 and 85. Alternatively, the process result 24 is pushed to the first user 5 and/or other users 84 and 85. The first user 5 and other users 84 and 85 may decide whether to subscribe to the second basic information directory 71 based on the new conditions/terms 703 of the second basic information directory 71. When the first user 5, second user 7 and other users 84 and 85 make their decision on whether to accept the conditions/terms of a specific information directory (first basic information directory 52 and/or second basic information directory 71), they are informed on the newest group composition of the term-specified group.

In short, the data processing system and method according to the embodiments of the present invention is used in the cloud environment of a distributed system to process/exchange information. When performing the steps of the data processing method using the data processing system disclosed in the present invention, first, set the basic information directory. Herein, the basic information directory is set with conditions/terms according to a specific subject matter. Next, perform repeated action. Herein, repeated action is performed on the basic information directory between users, so as to initiate directory iteration, generate derivative information directories and incident group composition changes. Last, forming the term-specified group composed of users for the specific subject matter. Herein, for the basic information directories and/or derivative information directories, the term-specified group composed of users is formed by users, and terms of transaction is negotiated among users for a specific subject matter, that is, for the derivative information directory generated by reciprocal iteration and/or basic information directories that are related to the specific subject matter, the term-specified group is formed by users who have accessed and accepted all the conditions/terms of the directory.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A data processing method employed in a cloud environment of a distributed system to process/exchange information, said method comprising the steps of:
setting a basic information directory;
performing reciprocal interoperation; and
forming a term-specified group composed of a plurality of users.

2. The data processing method according to claim 1, wherein during the step of setting said basic information directory, said basic information directory is defined with conditions/terms based on a specific subject matter, and an interoperable group is formed by the users.

3. The data processing method according to claim 1, wherein during the step of performing reciprocal interoperation, the users inform the members of an interoperable group of each series of an information directory through said distributed system, on the other hand, the users of said distributed systems, whom a user agent determines should inform, based on an analysis performed by the user agent, are also informed to subscribe to form said interoperable group of said information directory; wherein reciprocal interoperation is performed on said information directory among said users to initiate directory iteration, and further generate derivative information directories and incident composition change of said interoperable group.

4. The data processing method according to claim 1, wherein during the step of performing reciprocal interoperation, at least one second user can become a member of said term-specified group of said basic information directory by accepting the conditions/terms of said basic information directory set by a first user, thereby allowing transaction based on the conditions/terms of said basic information directory.

5. The data processing method according to claim 1, wherein during the step of performing reciprocal interoperation, a second user becomes a member of an interoperable group and a member of said term-specified group of said basic information directory by accepting the conditions/terms of said basic information directory set by a first user, thereby allowing transaction based on the conditions/terms of said basic information directory; yet, when new conditions/terms are added as an option of said basic information directory as feedback after said second user agrees to all the conditions/terms of said basic information directory, a new derivative information directory is generated, and said second user becomes a group member of an interoperable group of said derivative information directory and a group member of a term-specified group thereof, then, group members of said interoperable group of said basic information directory are informed to decide whether or not to join the derivative information directory to become group members of said interoperable group thereof, or further to become group members of said term-specified group, and perform transaction based on the conditions/terms of said basic information directory; wherein, said first user and said second user may add new conditions/terms during the process of reciprocal iteration of agreeing to the conditions/terms provided by each other.

6. The data processing method according to claim 1, wherein during the step of performing reciprocal interoperation, a second user partially modifies, partially accepts or declines the conditions/terms of said basic information directory set by a first user to become an option of said basic information directory, and a new derivative information directory is generated according to the new conditions/terms provided by said second user, and said second user becomes a group member of an interoperable group of said derivative information directory and a group member of a term-specified group thereof, then, group members of said interoperable group of said basic information directory are informed to decide whether or not to join the derivative information directory to become group members of said interoperable group thereof, or further become group members of said term-specified group, and perform transaction based on the conditions/terms of said derivative information directory; wherein, said first user and said second user may add new conditions/terms during the process of reciprocal iteration of partially modifying, partially accepting or declining the conditions/terms provided by each other.

7. The data processing method according to claim 1, wherein during the step of performing reciprocal interoperation, a second user accepts the conditions/terms of said basic information directory set by a first user, and becomes a member of an interoperable group of said basic information directory with said first user while becoming a group member of a term-specified group thereof, thereby allowing transaction based on the conditions/terms of said basic information directory; yet, after said second user provides new conditions/terms modified from the existing conditions/terms as an option of said basic information directory, a first derivative information directory is generated, and said second user becomes a group member of an interoperable group of said first derivative information directory and also becomes a member of a term-specified group thereof, then, group members of said basic information directory are informed to decide whether or not to join the first derivative information directory to become group members of said interoperable group thereof, or further become group members of said term-specified group, and perform transaction based on the conditions/terms of said first derivative information directory; wherein, if said first user provides other conditions/terms as an option of said first derivative information directory, a second derivative information directory is generated, and said first user becomes a group member of an interoperable group of said second derivative information directory and also becomes a group member of a term-specified group thereof, then, group members of said interoperable groups of said basic information directory and said first derivative information directory are informed to decide whether or not to join said second derivative information directory to become group members of said interoperable group thereof, or further become group members of said term-specified group thereof, said second user becomes a group member of said interoperable group and said term-specified group of said second derivative information directory by accepting the other conditions/terms provided by said first user, thereby allowing transaction based on the conditions/terms of said basic information directory.

8. The data processing method according to claim 1, wherein during the step of forming said term-specified group composed of said users, said term-specified group of users is formed based on a specific subject matter of information directories, and terms and conditions of transactions are negotiated by said users based on said specific subject matter.

9. A data processing method employed in a cloud environment of a distributed system to process/exchange information, said method comprising the steps of:
setting a basic information directory, wherein said basic information directory is defined with conditions/terms based on a specific subject matter;
performing reciprocal interoperation, wherein a master of an administration module decides the execution of a worker module, and reciprocal interoperation is performed on said basic information directory among a plurality of users to initiate directory iteration, generate a plurality of derivative information directories and incident change of composition of said term-specified group; and
forming a term-specified group composed of said users, wherein said term-specified group of said users is formed based on said specific subject matter of said basic information directory and/or said derivative information directories, and terms and conditions of transaction are negotiated by said users based on said specific subject matter.

10. The data processing method according to claim 9, wherein during the step of performing reciprocal interoperation, an interoperable group composed of a plurality of users can be further formed through recruiting activities; wherein said users recruited by said distributed systems subscribe to a specific directory, and interoperability among the group members of said specific directory is set so said users are able to access said specific directory, then, said users become the recipients for said distributed system to actively push messages to.

11. The data processing method according to claim 9, wherein during the step of performing reciprocal interoperation, after the conditions/terms of said basic information directory are set by a first user, and a second user provides conditions/terms of said basic information directory mutually exclusive from the conditions/terms set by said first user, a branch basic information directory is generated based on the new conditions/terms provided by said second user; wherein said branch basic information directory serves as the basic information directory of subsequent reciprocal interoperation, and said second user becomes a group member of an interoperable group and a term-specified group of said branch basic information directory.

12. The data processing method according to claim 9, wherein during the step of forming said term-specified group and an interoperable group composed of said users, the newest group composition of said term-specified group and said interoperable group of said users is acquired.

13. A data processing system employed in a cloud environment of a distributed system to process/exchange information, said system comprising:
an administration module having a master and a user agent;
at least one worker module, wherein said master of said administration module decides the operation and execution of said worker module; when a user updates the condition/terms defining a basic information directory, a derivative information directory is generated, then, said user agent informs said master to send the new conditions/terms provided by said user to said worker module to be sent off by said worker module; said user agent manages said worker module, said worker module inspects the conditions/terms of said basic information directory and said derivative information directories, and saves the process result from the inspection for later access; and
a storage module storing said basic information directories, said derivative information directories and said process results.

14. The data processing system according to claim 13, wherein said administration module, said at least one worker module and said storage module are set up using a cloud computing architecture.

15. The data processing system according to claim 14, wherein said basic information directory and said derivative information directories are the real estate selling information directories, and the condition/terms of said real estate selling information directories are the conditions/terms of the seller, which is related to real estate transaction information.

16. The data processing system according to claim 14, wherein said basic information directory and said derivative information directories are the real estate buying information directories, and the condition/terms of said real estate buying information directories are the conditions/terms of the buyer, which is related to real estate transaction information.

17. A data processing system employed in a cloud environment of a distributed system to process/exchange information, said system comprising:
an administration module having a master and a user agent;
at least one worker module, wherein said master of said administration module decides the operation and execution of said worker module; when a first user set the conditions/terms of a basic information directory, and a second user does not accept all the conditions/terms defining said basic information directory, said second user provides new conditions/terms to initiate iteration process and generate a derivative information directory, then, said user agent of said administration module sends the new condition/terms provided by said second user to said worker module to be sent off by said worker module; said user agent manages said worker module, said worker module inspects the conditions/terms of said basic information directory and said derivative information directories, and saves the process result from inspection for later access; and
a storage module storing said basic information directories, said derivative information directories and said process results.

18. The data processing system according to claim 17, wherein said administration module, said at least one worker module and said storage module are set up using cloud computing architecture.

19. The data processing system according to claim 18, wherein said basic information directory and said derivative information directories are the real estate selling information directories, and the condition/terms of said real estate selling information directories are the conditions/terms of the seller, which is related to real estate transaction information.

20. The data processing system according to claim 18, wherein said basic information directory and said derivative information directories are the real estate buying information directories, and the condition/terms of said real estate buying information directories are the conditions/terms of the buyer, which is related to real estate transaction information.
